(19) United States
(12) Patent Application Publication
(10) Pub. No.: US 2024/0097856 A1
(43) Pub. Date: Mar. 21, 2024

(54) DATA TRANSMISSION METHOD AND APPARATUS, STORAGE MEDIUM AND ELECTRONIC APPARATUS

(71) Applicant: SANECHIPS TECHNOLOGY CO., LTD., Shenzhen, Guangdong (CN)

(72) Inventor: Lin YANG, Shenzhen, Guangdong (CN)

(21) Appl. No.: 18/038,420

(22) PCT Filed: Sep. 9, 2021
(86) PCT No.: PCT/CN2021/117489

§ 371 Date: May 23, 2023

(30) Foreign Application Priority Data
Nov. 23, 2020 (CN) 202011323921.3

(51) Int. Cl. H04L 5/00; H04W 16/02

(52) U.S. Cl. CPC H04L 5/0053; H04L 5/0094; H04W 16/02

(57) ABSTRACT

A data transmission method and apparatus, a storage medium, and an electronic apparatus. The method includes control information or signaling information between a building baseband unit (BBU) and a radio remote unit (RRU) in a control word of a basic frame, where bits corresponding to the control word are part of bits of a first word (S302); and transmitting data in bits other than the control word in the first word of the basic frame and words other than the first word (S304).

### CROSS-REFERENCE TO RELATED APPLICATIONS

The present application is based on and claims a priority from the Chinese patent application No. 202011323921.3 filed on Nov. 23, 2020, the entire disclosure of which is incorporated herein by reference.

### TECHNICAL FIELD

Embodiments of the present disclosure relate to the field of communications, and in particular, to a data transmission method and apparatus, a storage medium, and an electronic apparatus.

### BACKGROUND

In the communication system, an access network typically divides station functions into two parts which are a building baseband unit (BBU) and a radio remote unit (RRU). The BBU, generally placed in a machine room, is configured to process baseband signals, may be connected to a plurality of RRUs, and has relatively good maintainability and high reuse rate; while the RRU has functions such as analog-to-digital conversion and radio frequency, antenna related functions. User data is transmitted between the BBU and the RRU mainly through a common public radio interface (CPRI).

With the development of various technologies in the communication field, 5G application scenarios are increasing, and operators have higher demands on the amount of user data and the amount of transmitted data. The CPRI protocol is desired to be advanced constantly to support higher and higher line bit rates. Currently, the latest CPRIv7.0 protocol specifies 11 line bit rates, the highest of which is 24.33024 Gbps (hereinafter referred to as 24G). Based on a user data proportion (15/16) in the frame format specified in the protocol, and in consideration of the necessary redundant coding (64b/66b coding) desired for long-distance transmission, an effective bandwidth actually used for carrying user data is merely 22.1148G, and the transmission efficiency is about 90.8% (effective bandwidth/actual line bit rate), which has a difference with the transmission efficiency of about 92% to 95% of Ethernet.

FIG. 1 is a schematic diagram of a basic frame structure specified in a CPRI protocol in some cases. As shown in FIG. 1, each basic frame is divided into 16 words (W), and each word includes T bits, where a first word is a control word configured to carry control information or signaling information between the BBU and the RRU. The rest 15 words are IQ (in-phase/quadrature-phase) data which carry user data. According to a frame format specified in the CPRI protocol, the user data occupies a bandwidth of 15/16, having a low transmission efficiency.

No solution has been proposed yet regarding the problem of low transmission efficiency in data transmission according to the frame format specified in the CPRI protocol in some cases.

### SUMMARY

According to an embodiment of the present application, there is provided a data transmission method, including: carrying control information or signaling information between a BBU and an RRU in a control word of a basic frame, wherein bits corresponding to the control word are part of bits of a first word; and transmitting data in bits other than the control word in the first word of the basic frame and words other than the first word.

According to another embodiment of the present application, there is further provided a data transmission apparatus, including: a carrying module configured to carry control information or signaling information between a BBU and an RRU in a control word of a basic frame, wherein bits corresponding to the control word are part of bits of a first word; and a data transmission module configured to transmit data in bits other than the control word in the first word of the basic frame and words other than the first word.

According to still another embodiment of the present application, there is further provided an electronic apparatus, including a memory and a processor, wherein the memory has a computer program stored thereon, and the processor is configured to execute the computer program to perform operations of any of the method embodiments described above.

### BRIEF DESCRIPTION OF DRAWINGS

FIG. 1 is a schematic diagram of a basic frame structure specified in a CPRI protocol in some cases;

FIG. 2 is a block diagram showing a hardware structure of a mobile terminal used in a data transmission method according to an embodiment of the present application;

FIG. 3 is a flowchart of a data transmission method according to an embodiment of the present application;

FIG. 4 is a schematic diagram showing word lengths at various line bit rates in the CPRI protocol according to an embodiment of the present application;

FIG. 5 is a schematic diagram of a basic frame structure in a conventional optimization mode according to an embodiment of the present application;

FIG. 6 is a schematic diagram showing a bandwidth of fast signaling and the number of bits occupied by each basic frame in a CPRI frame format according to an embodiment of the present application;

FIG. 7 is a schematic diagram of a basic frame structure in a limit optimization mode according to an embodiment of the present application;

FIG. 8 is a schematic diagram of a virtual basic frame structure according to an embodiment of the present application;

FIG. 9 is a schematic diagram of an A×C sequence adjustment pattern in the limit optimization mode according to an embodiment of the present application;

FIG. 10 is a schematic diagram showing a frame structure of a first basic frame per superframe in the limit optimization mode according to an embodiment of the present application;

FIG. 11 is a schematic diagram showing user data bandwidths and transmission efficiencies in different modes according to an embodiment of the present application; and

FIG. 12 is a block diagram of a data transmission apparatus according to an embodiment of the present application.

### DETAIL DESCRIPTION OF EMBODIMENTS

Embodiments of the present application will be described in detail below with reference to the accompanying drawings in conjunction with embodiments.

It should be noted that terms “first”, “second”, and the like in the description, claims and drawings of the present application are used for the purpose of distinguishing similar objects instead of indicating a specific order or sequence.

The process embodiment provided in the embodiments of the present application may be implemented in a mobile terminal, a computer terminal or any other computing apparatus. Taking running on a mobile terminal as an example, FIG. 2 is a block diagram showing hardware structures of a mobile terminal used in a data transmission method according to an embodiment of the present application, and as shown in FIG. 2, the mobile terminal may include one or more processors 102 (merely one processor is shown in FIG. 2) (the processor 102 may include, but is not limited to, a microprocessor (MCU) or a processing device of a programmable logic device (FPGA) or the like), and a memory 104 configured to store data. The mobile terminal may further include a transmission device 106 for communication functions and an input/output device 108. It will be understood by those ordinary skilled in the art that the structure shown in FIG. 2 is merely illustrative, and does not form any limitation to the structure of the mobile terminal. For example, the mobile terminal may include more or fewer components than those as shown in FIG. 2, or may have a different configuration than that as shown in FIG. 2.

The memory 104 may be configured to store a computer program, for example, a software program and modules of application software, such as a computer program corresponding to the data transmission method provided in the embodiments of the present application, while the processor 102, by executing the computer program stored on the memory 104, performs various functional applications and slicing of a service chain address pool, that is, implements the above method. The memory 104 may include a high speed random access memory, or may include a non-volatile memory such as one or more magnetic storage devices, flash memories, or other non-volatile solid state memories. In some examples, the memory 104 may further include a memory remotely disposed relative to the processor 102, which may be connected to the mobile terminal via a network. Examples of such networks include, but are not limited to, the Internet, intranets, local area networks, mobile communication networks, and combinations thereof.

The transmission device 106 is configured to receive or transmit data via a network. Specific examples of such networks may include a wireless network provided by a communication provider of the mobile terminal. In an example, the transmission device 106 includes a network interface controller (NIC) that may be connected to another network device through a base station to communicate with the Internet. In an example, the transmission device 106 may be a radio frequency (RF) module configured to communicate with the Internet wirelessly.

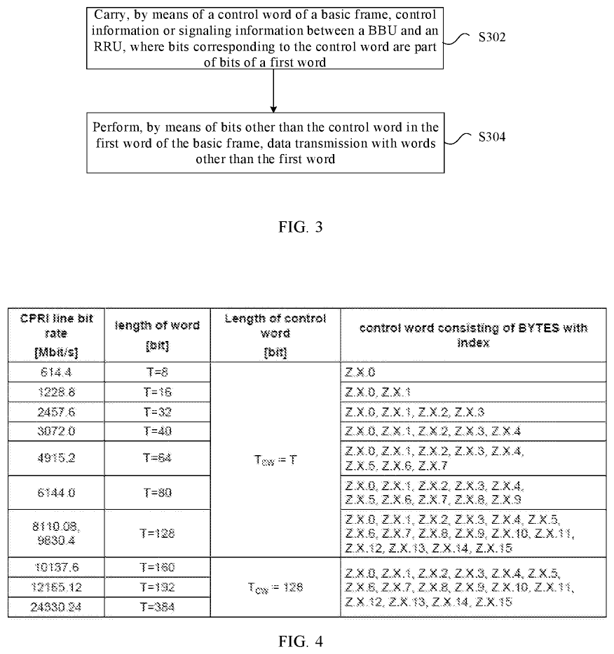

In this embodiment, there is provided a data transmission method operating in the mobile terminal or network architecture as described above. FIG. 3 is a flowchart of a data transmission method according to an embodiment of the present application. As shown in FIG. 3, the flow includes the following operations S302 to S304.

At operation S302, carrying control information or signaling information between a BBU and an RRU in a control word of a basic frame, where bits corresponding to the control word are part of bits of a first word of the basic frame.

In a CPRI protocol, the basic frame includes 16 words, and each word includes T bits.

At operation S304, transmitting data in bits other than the control word in the first word of the basic frame and words other than the first word.

Through the above operations S302 to S304, the control information or signaling information between a BBU and an RRU is carried in a control word of the basic frame, where bits corresponding to the control word are part of bits of the first word; and data is transmitted in bits other than the control word in the first word of the basic frame and words other than the first word. Therefore, the problem of low transmission efficiency in data transmission according to the frame format specified in the CPRI protocol in some cases can be solved, and by reducing the number of bits occupied by the control word, the interface transmission mode is optimized, the bearable data amount is increased, and the data transmission efficiency is improved.

In an embodiment, the above operation S302 may include: acquiring a bandwidth occupied by the control information or the signaling information at a current line bit rate, determining, according to a preset correspondence relationship between the bandwidth occupied by the control information or the signaling information and a bandwidth occupied by the control word at different line bit rates, a target bandwidth occupied by the control word corresponding to the current line bit rate, and carrying the control information or the signaling information with the control word corresponding to the determined target bandwidth.

In an embodiment, before carrying the control information or signaling information between the BBU and the RRU, in the control word of the basic frame, it is determined according to a use scenario at the current line bit rate that the control information or the signaling information occupies a bandwidth M times of a reference bandwidth. The reference bandwidth is a bandwidth occupied by the control information or the signaling information at a line bit rate of 614.4 Mbps. That is, the bandwidth occupied by the control information or the signaling information at the line bit rate of 614.4 Mbps is set to the reference bandwidth of the control word and the signaling information, under which the control information or the signaling information occupies 8 bits in each basic frame. Since at the line bit rate of 614.4 Mbps, W=0 has a word length T=8, the reference bandwidth of the control word or signaling is 8*3.84=30.72 Mbps. It is determined under the use scenario that the control information or the signaling information occupies 8*M bits in each basic frame, where M is an integer greater than or equal to 1.

In an embodiment, the above operation S304 may include: combining N basic frames according to a frame format at N times the line bit rate to obtain a virtual frame, where N is a positive integer capable of being divided by 150, the virtual frame includes the N basic frames, and merely a first basic frame in the N basic frames includes the control word; combining 256 virtual frames into a superframe, and combining 150/N superframes into a radio frame; and transmitting data with the radio frame.

In an embodiment, the control word of a first basic frame of the superframe is set in a middle bit of a first word of the first basic frame, and a synchronization byte is set in the control word of the first basic frame of the superframe.

In another embodiment, the above operation S304 may further include: carrying data in words other than the first word, carrying newly added data in bits of the first word other than the control word, and performing data transmission with the basic frame.

In an embodiment, the data carried in the bits of the first word other than the control word is checked to obtain a mnemonic check code (a first check code); the data carried in the words other than the first word is checked to obtain a second check code; and the first check code and the second check code are carried in the control word.

This embodiment may be applied to a scenario where data transmission between a BBU and an RRU of an access network station is performed through a CPRI interface in a communication system.

By optimizing the CPRI frame format, more user data can be carried at a given line bit rate so that a larger data volume can be supported without increasing a processing clock of the chip, and the design complexity of the chip is reduced. Therefore, more user data can be carried at the current rate, the line bit rate does not need to be further increased, and a more advanced optical module of higher cost is saved. Further, a single optical fiber can carry more data, and the expenditure on consumptive optical fibers of operators is saved.

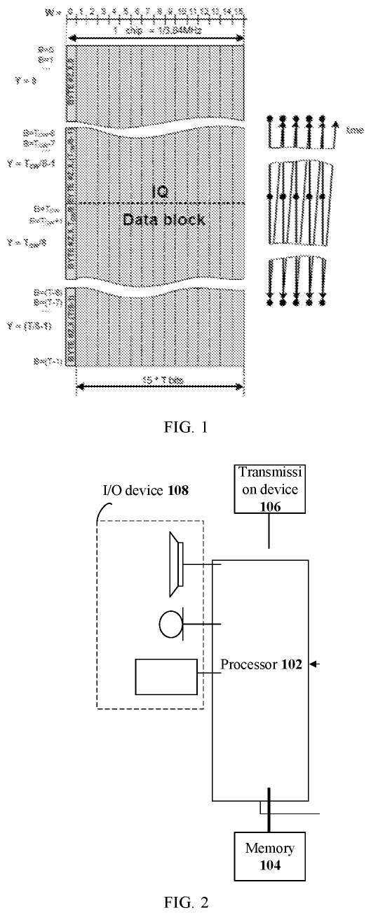

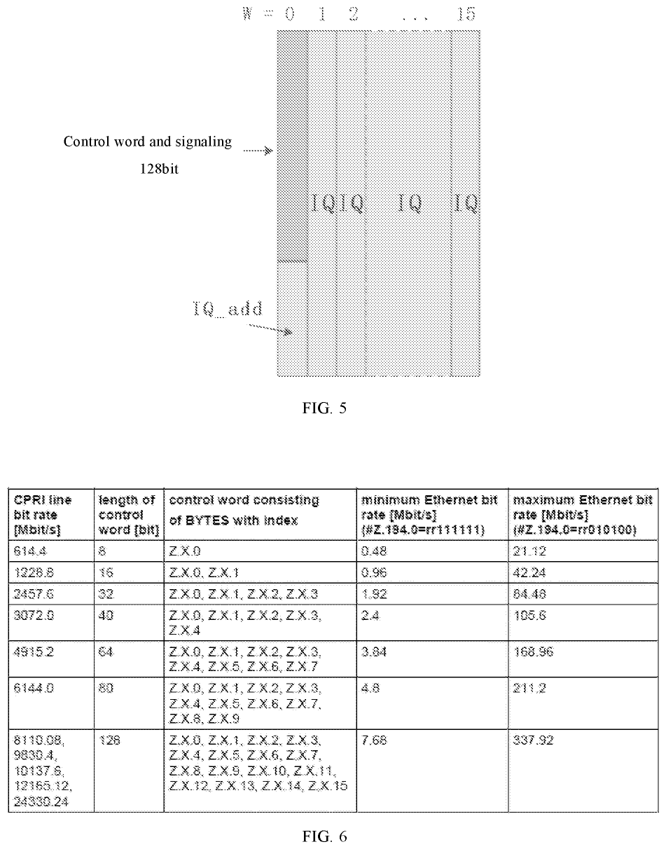

The basic frame structure of the CPRI interface is optimized. A basic frame format specified in the CPRI protocol is shown in FIG. 1, where each basic frame is divided into 16 words (W), and each word includes T bits. A first word is a control word configured to carry control information or signaling information between the BBU and the RRU. The remaining 15 words are IQ (in-phase/quadrature-phase) data which carry user data. According to the frame format specified in the CPRI protocol, the user data occupies a bandwidth of 15/16. In order to improve the transmission efficiency of the user data, the bandwidth occupied by the control word is to be reduced. FIG. 4 is a schematic diagram showing word lengths at various line bit rates in the CPRI protocol according to the embodiment. As shown in FIG. 4, when the line bit rate is less than 10.1376G (hereinafter referred to as 10G), the control word length (Tcw) is the word length; and when the rate is 10G or more, the control word length is fixed to 128 bits, while the word length increases with the rate. Considering that the line bit rate is typically higher than 10G in current 4G and 5G large data volume application scenarios, this embodiment mainly discusses cases where the rate is above 10G. FIG. 5 is a schematic diagram of a basic frame structure in a conventional optimization mode according to the embodiment. As shown in FIG. 5, as the line bit rate increases, the control word length is up to 128 bits at most, and then all the T-Tcw part can be used to transmit user data. This mode is called conventional optimization mode in the embodiment, where IQ_add represent a newly added transmission position for user data. Taking 24G as an example, the user data bandwidth is increased to 23.10144 Gbps, with a transmission efficiency of 94.9%.

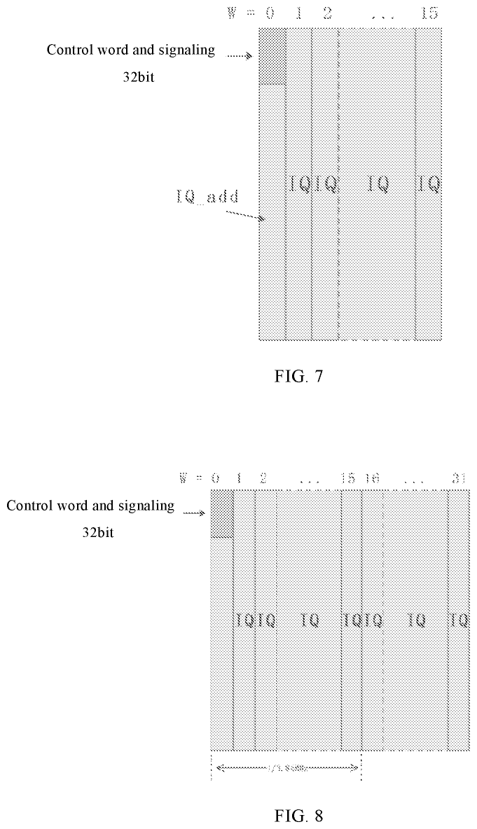

Further optimization will occupy the Tcw. A bandwidth occupied by the control word or signaling at a line bit rate of 614.4 Mbps is set to the reference bandwidth of the control word and the signaling information, under which the control word or signaling information occupies 8 bits in each basic frame. Since at the line bit rate of 614.4 Mbps, W=0 has a word length T=8, the reference bandwidth of the control word or signaling is 8*3.84=30.72 Mbps. Considering that most control words specified in the CPRI protocol have a bit width within 32 bits, that is, the control word or signaling has a band width less than 4 times of the reference bandwidth in most use scenarios, it is determined that the control word or signaling occupies 8*4=32 bits in each basic frame under corresponding scenarios. The user data transmission bandwidth can be further optimized as long as special treatment is carried out on control words with a bit length exceeding 32 bits. FIG. 6 is a schematic diagram showing a bandwidth of fast signaling and the number of bits occupied by each basic frame in a CPRI frame format according to the embodiment. As shown in FIG. 6, taking signaling information as an example, as the line bit rate increases, the bandwidth of the signaling information occupies at most 128 bits per basic frame. However, it has been found in practical applications that the signaling information is transmitted in high traffic in merely limited scenarios, such as BBU and RRU initial chain establishment and version upgrading, in which the user data is not concerned, while a very small bandwidth is desired in other situations. In this embodiment, the bandwidth of the signaling information is adjusted to be dynamically configurable so that first 128 bits of the basic frame are occupied only in a few scenarios, while only 32 bits are occupied in the rest time. FIG. 7 is a schematic diagram of a basic frame structure in a limit optimization mode according to the embodiment. As shown in FIG. 7, for other control words each occupying more than 32 bits per basic frame, a similar processing method may be adopted, and the occupied bandwidth may be appropriately reduced in combination with the actual application scenario. In this manner, each superframe has 96 additional bits available for user data transmission. This mode is referred to as limit optimization mode in this embodiment. Taking 24G as an example, the user data bandwidth is increased to 23.47008 Gbps, with a transmission efficiency of 96.4%.

To further optimize the transmission efficiency, a virtual frame format is further designed in an embodiment. According to the CPRI protocol, each basic frame has a time period of 1/3.84 MHz, 256 basic frames form one superframe, the control word or signaling information circulates once per superframe, and 150 superframes form a radio frame with a time period of 10 ms. When the line bit rate is determined, data is framed in a frame format that is N times the rate, where N is a positive integer capable of being divided by 150. Continuing to take 24G as an example, assuming that N is 5, the word length of the basic frame at 24G is 384 bits, and according to the existing protocol rate evolution mode, a 48G frame format with doubled data volume is constructed, with a word length of 768 bits. FIG. 8 is a schematic diagram of a virtual basic frame structure according to the embodiment. As shown in FIG. 8, the virtual 48G frame format is carried on an actual 24G channel, and the data of one virtual basic frame is processed by the time of two basic frames, so that the number of transmissions of the control word is reduced, the bandwidth of user data is increased to 23.53152 Gbps, with a transmission efficiency of 96.7%, and the transmission efficiency is higher when N is larger. In this manner, both the basic frame and the superframe have increased time, so the number of superframes included in the 10 ms radio frame becomes 150/N, and the number of occupied superframes of some serial control words is desired to be adjusted, while parallel control words are not affected. In addition, since 64b/66b redundancy coding is unavoidable in high-speed serial transmission, N is further increased, and the transmission efficiency approaches 96.97% (64±66) without exceeding this limit.

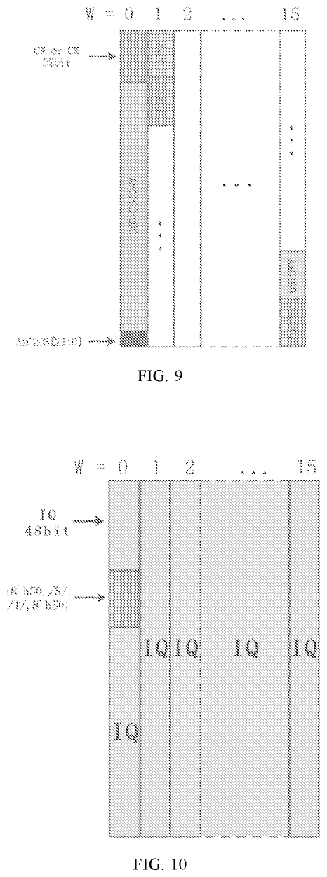

Since the IQ data volume that can be carried on each basic frame increases after optimization, an upstream data processing module is desired to transmit more IQ data to the CPRI framing module within each basic frame time. Continuing to take a line bit rate of 24G as an example and assuming that the A×C (IQ container) has a bit width of 30 bits, 192 A×Cs are processed per basic frame in the CPRI default frame format, 200.5 in the conventional optimization mode, and 203.7 in the limit optimization mode. FIG. 9 is a schematic diagram of an A×C sequence adjustment pattern in the limit optimization mode according to the embodiment. As shown in FIG. 9, a sequence of the A×Cs is desired to be adjusted during framing, and a newly added part is placed at an optimized position of W=0, so that the device according to this embodiment can be compatible with existing devices, and A×C 0-191 can be processed on both new and old devices, while A×C 192-203 can be processed on the new device only. Two additional points are desired to be noted: first, the A×C 203 has only 22 bits because of bandwidth limitation; and second, the newly added A×C is also desired to be checked, where CRC cyclic redundancy check is used in this embodiment, the generated redundancy check codeword is placed at a vendor specific control word position specified in a protocol, and check codes of the newly added A×C part and the original A×C part are separated to be compatible with existing devices.

FIG. 10 is a schematic diagram showing a frame structure of a first basic frame per superframe in the limit optimization mode according to the embodiment. As shown in FIG. 10, after adjustment, the A×Cs enter a framing module together with the control word and the signaling information, and framing is performed according to the basic frame format in FIG. 7. In this operation, a first basic frame of each superframe is desired to be subjected to special processing. A synchronization word (/S/ and /T/ codes) specified in the CPRI protocol occupies seventh and eighth bytes in the first basic frame, while 1 byte for 8′h50 is placed before and after the two bytes, respectively, and positions of the 4 bytes cannot be changed, so locations of the A×Cs optimized by the first basic frame W=0 are adjusted according to the synchronization word. Since the synchronization word also occupies 32 bits, the first basic frame differs from other basic frames merely in pattern, while the user data bandwidth is the same.

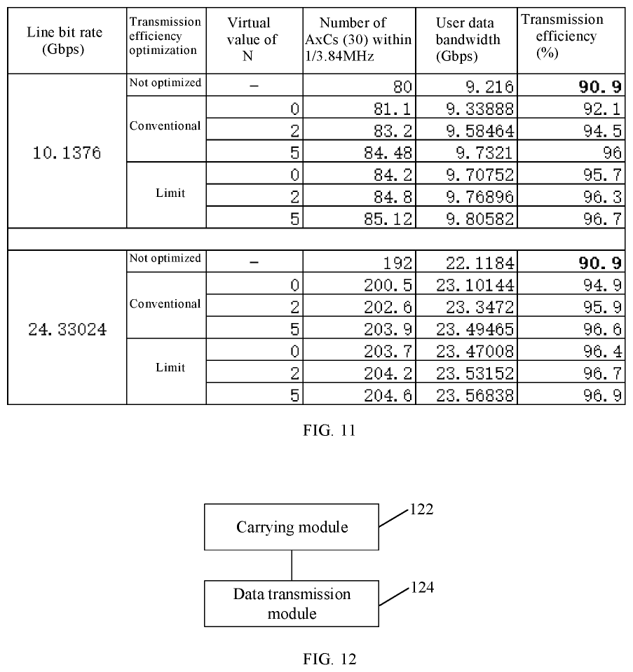

In implementation of construction of the virtual frame format, the number of clock cycles of each basic frame is desired to be adjusted according to N. Continuing to take 24G and N=2 as an example and given that a data stream bit width is 32 bits, then the control word of each basic frame and the A×Cs have 192 pieces of data in total. In some cases, the number of clock cycles per basic frame is 192, and in the virtual frame format, the number of clock cycles is configured to 384. The time of each virtual basic frame is 2/3.84 Mhz, each virtual basic frame of the upstream data processing module transmits 408.5 A×Cs to the CPRI framing module, and then framing is performed according to the format in FIG. 6. FIG. 11 is a schematic diagram showing user data bandwidths and transmission efficiencies in different modes according to the embodiment. As shown in FIG. 11, user data bandwidths and transmission efficiencies in various optimization modes for 10G and 24G are listed.

According to another embodiment of the present application, there is further provided a data transmission apparatus. FIG. 12 is a block diagram of a data transmission apparatus according to an embodiment of the present application. As shown in FIG. 12, the apparatus includes:

a carrying module 122 configured to carry control information or signaling information between a BBU and an RRU in a control word of a basic frame, where the basic frame includes 16 words, each word includes T bits, and bits corresponding to the control word are part of bits of a first word of the basic frame; and
a data transmission module 124 configured to transmit data in bits other than the control word in the first word of the basic frame and words other than the first word.

In an embodiment, the carrying module 122 includes:
an acquisition submodule configured to acquire a bandwidth occupied by the control information or the signaling information at a current line bit rate; and
a determination submodule configured to determine, according to a preset correspondence relationship between the bandwidth occupied by the control information or the signaling information and a bandwidth occupied by the control word at different line bit rates, a target bandwidth occupied by the control word corresponding to the current line bit rate; and
the carrying module 122 is further configured to carry the control information or the signaling information with the control word corresponding to the determined target bandwidth.

In an embodiment, the apparatus further includes:
a first determination module configured to determine, according to a use scenario at the current line bit rate, that the control information or the signaling information occupies a bandwidth M times of a reference bandwidth, where the reference bandwidth is a bandwidth occupied by the control information or the signaling information at a line bit rate of 614.4 Mbps; and
a second determination module configured to determine, under the use scenario, that the control information or the signaling information occupies 8*M bits in each basic frame, where M is an integer greater than or equal to 1.

In an embodiment, the data transmission module 124 includes:
a combination submodule configured to combine N basic frames according to a frame format at N times the line bit rate to obtain a virtual frame, where N is a positive integer capable of being divided by 150, the virtual frame includes the N basic frames, and merely a first basic frame in the N basic frames includes the control word;
a combination submodule configured to combine 256 virtual frames into a superframe, and combine 150/N superframes into a radio frame; and
a first transmission submodule configured to transmit data with the radio frame.

In an embodiment, the apparatus further includes:
a setting module configured to set the control word of a first basic frame of the superframe in a middle bit of a first word of the first basic frame, and set a synchronization byte in the control word of the first basic frame of the superframe.

In an embodiment, the data transmission module 124 includes:
a first carrying submodule configured to carry data in words other than the first word;
a second carrying submodule configured to carry newly added data in bits of the first word other than the control word; and
a second transmission submodule configured to perform data transmission with the basic frame.

In an embodiment, the apparatus further includes:
a first checking module configured to check the data carried in the bits of the first word other than the control word, to obtain a mnemonic check code (i.e., first check code);
a second checking module configured to check the data carried in the words other than the first word, to obtain a second check code; and
a third carrying module configured to carry the first check code and the second check code in the control word.

An embodiment of the present application further provides a computer-readable storage medium having a computer program stored thereon, where the computer program is configured to, when executed, cause operations of any of the method embodiments as described above to be implemented.

In an exemplary embodiment, the computer-readable storage medium may include, but is not limited to: a U disk, a read-only memory (ROM), a random access memory (RAM), a mobile hard disk, a disk or optical disk, or any other medium that can store a computer program.

An embodiment of the present application further provides an electronic apparatus, including a memory and a processor, where the memory has a computer program stored thereon, and the processor is configured to execute the computer program to perform operations of any of the method embodiments as described above.

In an exemplary embodiment, the electronic apparatus may further include a transmission device and an input/output device. The transmission device is connected to the processor, and the input/output device is connected to the processor.

Specific examples in the present embodiment may refer to the examples described in the foregoing embodiments and exemplary implementations, which will not be repeated in the present embodiment.

In the embodiments of the present application, control information or signaling information between a BBU and an RRU is carried in a control word of a basic frame, where bits corresponding to the control word are part of bits of a first word; and data is transmitted in bits other than the control word in the first word of the basic frame and words other than the first word. Therefore, the problem of low transmission efficiency in data transmission according to the frame format specified in the CPRI protocol in some cases can be solved, and by reducing the number of bits occupied by the control word, the interface transmission mode is optimized, the bearable data amount is increased, and the data transmission efficiency is improved.

Obviously, a person skilled in the art would understand that the above modules and operations of the present application can be realized by a universal computing device, can be integrated in a single computing device or distributed on a network that consists of a plurality of computing devices; and alternatively, they can be realized by using the executable program code of the computing device, so that they can be stored in a storage device and executed by the computing device in some cases, can perform the shown or described operations in a sequence other than herein, or they are made into various integrated circuit modules respectively, or a plurality of modules or operations thereof are made into a single integrated circuit module, thus to be realized. In this way, the present application is not restricted to any particular hardware and software combination.

The descriptions above are merely some embodiments of the present application, which are not used to restrict the present application. For those skilled in the art, the present application may have various changes and variations. Any amendments, equivalent substitutions, improvements, etc. within the principle of the present application are all included in the scope of the protection defined by the appended claims of the present application.

1. A data transmission method, comprising:
carrying control information or signaling information between a building baseband unit (BBU) and a radio remote unit (RRU) in a control word of a basic frame, wherein bits corresponding to the control word are part of bits of a first word of the basic frame; and
transmitting data in bits other than the control word in the first word of the basic frame and words other than the first word.

2. The method according to claim 1, wherein carrying the control information or signaling information between the BBU and the RRU in the control word of the basic frame, comprises:
acquiring a bandwidth occupied by the control information or the signaling information at a current line bit rate;
determining, according to a preset correspondence relationship between the bandwidth occupied by the control information or the signaling information and a bandwidth occupied by the control word at different line bit rates, a target bandwidth occupied by the control word corresponding to the current line bit rate; and
carrying the control information or the signaling information with the control word corresponding to the determined target bandwidth.

3. The method according to claim 2, wherein before carrying the control information or signaling information between the BBU and the RRU in the control word of the basic frame, the method further comprises:
determining, according to a use scenario at the current line bit rate, that the control information or the signaling information occupies a bandwidth M times of a reference bandwidth, wherein the reference bandwidth is a bandwidth occupied by the control information or the signaling information at a line bit rate of 614.4 Mbps;
determining, under the use scenario, that the control information or the signaling information occupies 8*M bits in each basic frame, wherein M is an integer greater than or equal to 1.

4. The method according to claim 1, wherein transmitting data in the bits other than the control word in the first word of the basic frame and the words other than the first word comprises:
combining N basic frames according to a frame format at N times the line bit rate to obtain a virtual frame, wherein N is a positive integer capable of being divided by 150, the virtual frame includes the N basic frames, and merely a first basic frame in the N basic frames includes the control word;
combining 256 virtual frames into a superframe, and combining 150/N superframes into a radio frame; and
transmitting data with the radio frame.

5. The method according to claim 4, wherein the method further comprises:
setting the control word of a first basic frame of the superframe in a middle bit of the first word of the first basic frame, and setting a synchronization byte in the control word of the first basic frame of the superframe.

6. The method according to claim 1, wherein transmitting data in the bits other than the control word in the first word of the basic frame and the words other than the first word comprises:
carrying data in words other than the first word;
carrying newly added data in bits of the first word other than the control word; and
performing data transmission with the basic frame.

7. The method according to claim 1, wherein the method further comprises:
checking data carried in the bits of the first word other than the control word, to obtain a first check code;
checking data carried in the words other than the first word, to obtain a second check code; and
carrying the first check code and the second check code in the control word.

8. A data transmission apparatus, comprising:
a carrying module configured to carry control information or signaling information between a building baseband unit (BBU) and a radio remote unit (RRU) in a control word of a basic frame, wherein bits corresponding to the control word are part of bits of a first word of the basic frame; and
a data transmission module configured to transmit data in bits other than the control word in the first word of the basic frame and words other than the first word.

9. A computer-readable non-instantaneous storage medium with a computer program stored thereon, wherein the computer program is configured to, when executed, causes the method according to claim 1 to be implemented.

10. An electronic apparatus, comprising a memory and a processor, wherein the memory has a computer program stored thereon, and the processor is configured to execute the computer program to perform the method according to claim 1.

11. The method according to claim 2, wherein the method further comprises:
checking data carried in the bits of the first word other than the control word, to obtain a first check code;
checking data carried in the word other than the first word, to obtain a second check code; and
carrying the first check code and the second check code in the control word.

12. The method according to claim 3, wherein the method further comprises:
checking data carried in the bits of the first word other than the control word, to obtain a first check code;
checking data carried in the word other than the first word, to obtain a second check code; and
carrying the first check code and the second check code in the control word.

13. The method according to claim 4, wherein the method further comprises:
checking data carried in the bits of the first word other than the control word, to obtain a first check code;
checking data carried in the word other than the first word, to obtain a second check code; and
carrying the first check code and the second check code in the control word.

14. The method according to claim 5, wherein the method further comprises:
checking data carried in the bits of the first word other than the control word, to obtain a first check code;
checking data carried in the word other than the first word, to obtain a second check code; and
carrying the first check code and the second check code in the control word.

15. The method according to claim 6, wherein the method further comprises:
checking the data carried in the bits of the first word other than the control word, to obtain a first check code;
checking the data carried in the word other than the first word, to obtain a second check code; and
carrying the first check code and the second check code in the control word.
